(19) United States
(12) Patent Application Publication
(10) Pub. No.: US 2014/0152071 A1
(43) Pub. Date: Jun. 5, 2014

(54) Bent Tube With Foam Reinforcement And Method

(71) Applicant: JOHNSON CONTROLS TECHNOLOGY COMPANY, Holland, MI (US)

(72) Inventors: Daniel J. Sakkinen, Highland, MI (US); Michael J. Thomas, Ann Arbor, MI (US)

(21) Appl. No.: 14/233,526

(22) PCT Filed: Jul. 19, 2012
(86) PCT No.: PCT/US12/47273

§ 371 Date: Jan. 21, 2014

Related U.S. Application Data
(60) Provisional application No. 61/509,313, filed on Jul. 19, 2011.

(51) Int. Cl. B60N 2/68; B21D 7/16; B68G 15/00

(52) U.S. Cl. CPC B60N 2/68; B68G 15/00; B21D 7/16
USPC 297/452.2; 29/91; 72/369; 72/342.94

(57) ABSTRACT

A foam reinforced and bent tube for use in a vehicle seat frame and a method of forming such a tube are provided. The tube has a cavity which extends along its length and at least one open end. The foam may be inserted into the cavity through any desirable process including, for example, injection. The bend is formed by heating a portion of the tubular element and bending it at the heated region. The insertion of the foam material into the cavity of the tubular element may precede, follow or be simultaneous with the heating and bending processes. The foam material may have a variable type and/or a variable density through the length of the cavity.

### CROSS REFERENCE TO RELATED APPLICATIONS

This U.S. National Stage Patent Application claims priority to International Application Serial No. PCT/US2012/047273 filed Jul. 19, 2012, entitled “Bent Tube With Foam Reinforcement And Method,” which claims the benefit of U.S. Provisional Application Ser. No. 61/509,313, filed on Jul. 19, 2011, entitled “Bent Tube With Foam Reinforcement And Method,” the entire disclosures of the applications being considered part of the disclosure of this application and hereby incorporated by reference.

### BACKGROUND OF THE INVENTION

1. Field of the Invention

The present invention relates generally to frames for vehicle seats. More specifically, the present invention relates to frames including at least one elongated tubular element reinforced with a foam material.

2. Description of the Prior Art

In the event of automobile collisions, whether between two vehicles or with a stationary object, the driver and passenger seats located in the cabin of the vehicle may be subjected to very high loads and must be designed to resist deformation under those loads in order to protect any occupants seated therein. At the same time, cost effectiveness and mass reduction (which results in better performance and fuel economy for the vehicle) are also important objectives so long as the strength of the seat is not compromised.

Typical vehicle seats include a back frame and a lower seat frame, each of which may include one or more tubular elements. Some seating manufacturers produce tubular elements of strong materials and with sufficient thickness to withstand vehicle accidents. Others produce tubular elements of weaker and/or thinner materials but with a reinforcing agent disposed therein to provide increased strength for withstanding vehicle collisions.

### SUMMARY OF THE INVENTION

According to one aspect of the present invention, a vehicle seat frame assembly is provided including at least one elongated tubular element having a cavity and extending between distal ends with at least one bend. A foam material is disposed in the cavity and completely fills the cross-sectional area of the cavity through at least a portion of the length of the elongated tubular element. The foam material has at least one of a varying type and a varying density along the portion of the length of the cavity to reinforce the tubular element. This provides for cost savings because the tubular element can be formed of a thinner and/or weaker material and still be strong enough to resist deformation from the forces which may result from vehicle collisions.

According to another aspect of the present invention, a method of forming a vehicle seat is provided. The method includes the step of preparing at least one elongated tubular element having a cavity and extending lengthwise between opposite ends. The method also includes inserting a foam material into at least a portion of the cavity of the tubular element. The foam material could be inserted into the cavity through any suitable process including, for example, as an expandable plug or as a resin. The method proceeds with heating and bending at least a portion of the tubular element. The heating and bending of the tubular element may precede, follow, or be simultaneous with the insertion of the foam material into the cavity.

According to yet another aspect of the present invention, another method of forming a vehicle seat is provided. The method includes the step of preparing at least one elongated tubular element having a cavity and extending lengthwise between opposite ends with at least one of the opposite ends being open and with at least one spacer being disposed in the cavity between the opposite ends. The method continues with the step of inserting an injector having a radially outwardly extending flange into the cavity through the open end to a position with the flange being spaced from the spacer. The method proceeds with the step of injecting a foam material into the cavity between the spacer and the flange of the injector. The method continues with the step of removing the injector from the cavity. The method additionally includes the steps of heating and bending the tubular element. The injecting of the foam material into the cavity could precede, follow, or be simultaneous with the heating and bending steps. This process is a particularly efficient and cost effective process of providing reinforcement for the tubular element.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a perspective view of an exemplary bent and foam reinforced tubular element;

FIG. 2 is a cross-sectional view of the exemplary tubular element taken along line 2-2 of FIG. 1;

FIG. 3 is a flow chart of a first exemplary method of forming a foam reinforced and bent tubular element;

FIG. 4 is a flow chart of a second exemplary method of forming a foam reinforced and bent tubular element;

FIG. 5 is a flow chart of a third exemplary method of forming a foam reinforced and bent tubular element;

FIG. 6 is a cross-sectional view of an exemplary tubular element with an injector being positioned therein for injecting a resin into the cavity of the tubular element;

FIG. 7 is a flow chart of a fourth exemplary method of forming a foam reinforced and bent tubular element;

FIG. 8 is perspective view of an exemplary tubular element undergoing a line induced thermal straining (LITS) process;

FIG. 9 is an enlarged view showing the microstructure of an exemplary material of the tubular element of FIG. 8 at various points following the LITS process;

FIG. 10a is a cross-sectional view of an exemplary tubular element which was bent using the LITS process; and

FIG. 10b is a table showing test results of the tubular element of FIG. 10a taken at various points along the bend.

### DESCRIPTION OF THE ENABLING EMBODIMENT

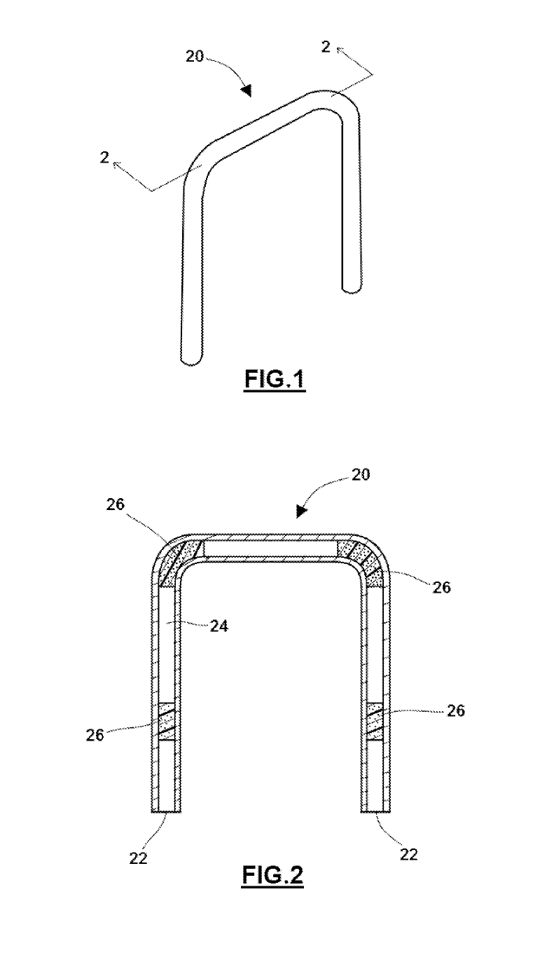

Referring to the Figures, wherein like numerals indicate corresponding parts throughout the several views, an exemplary elongated tubular element 20 for use with either the back frame or the lower seat frame of a vehicle seat and constructed according to one aspect of the present invention is generally shown in FIG. 1. The exemplary tubular element 20 has a generally circular shape as viewed in cross-section. However, it should be appreciated that the tubular element 20 could be formed with any desirable cross-sectional shape. The tubular element 20 is preferably formed of steel or aluminum; however, it could alternately be of any suitable metallic or non-metallic material.

Referring now to FIG. 2, the tubular element 20 has open ends 22 and an open cavity 24 extending between the open ends 22. A foam material 26 is selectively disposed in the cavity 24 and completely fills the cross-sectional area of the cavity 24 through predetermined portions of the tubular element 20. The foam material 26 provides reinforcement to those predetermined portions of the tubular element 20 for additional strength to resist deformation from the forces which may occur during a vehicle collision. This allows the tubular element 20 to be formed with a reduced wall thickness and/or formed of a lighter, weaker, and/or cheaper material without compromising its ability to resist deformation or failure from the forces which may occur during a vehicle collision. It may be advantageous to select the wall thickness and material of the tubular element 20 according to the areas which require the least amount of strength to resist deformation during vehicle collisions and to reinforce the other areas which require additional strength with the foam material 26. As such, the cost and/or weight of the tubular element 20 can be reduced without compromising its performance.

Even further, additional cost savings can be realized by varying the type and/or density of the foam material 26 along the length of the cavity 24. For example, the foam material 26 could be more or less dense in portions of the tubular element 20 which require more reinforcement to resist loads that may occur during vehicle collisions, whereas the foam material 26 could be more or less dense in portions of the tubular element 20 which require less reinforcement. It should be noted that, depending on the type of foam material 26 employed, an increased density may not increase the reinforcement of the tubular element 20 by the foam material 26. The foam material 26 is preferably a polyurethane foam material 26. However, any other type suitable type of foam material 26 may alternately be employed.

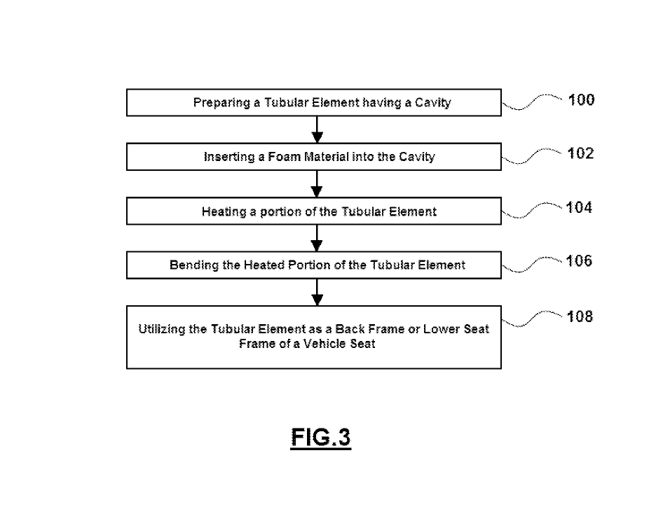

The exemplary tubular element 20 extends lengthwise through a pair of bends. These bends can be formed into the tubular element 20 before, during, or after the insertion of the foam material 26 into the cavity 24. FIGS. 3-5 are flow charts showing three different exemplary methods of forming a bent and reinforced tubular element 20, such as the one shown in FIGS. 1 and 2.

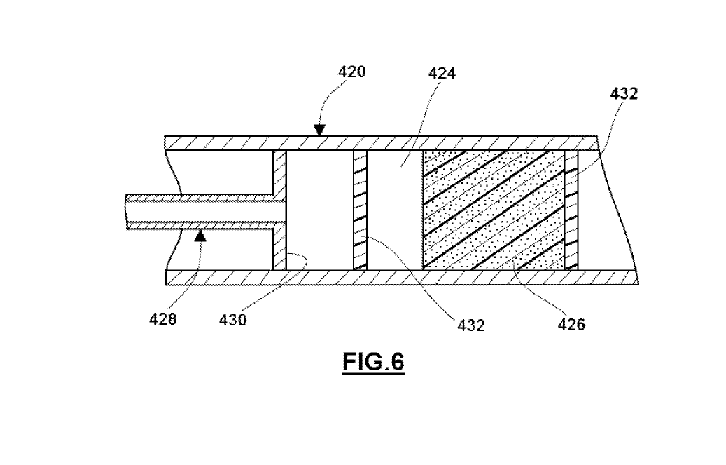

Referring now to the flow chart of FIG. 3 and the structure of FIGS. 1 and 2, a first exemplary process of forming a bent and reinforced tubular element 20 includes the step 100 of preparing a tubular element 20 having a cavity 24 and a predetermined length. The preparing step 100 could be, for example, roll forming or cutting a tubular element 20. The exemplary method then proceeds with the step 102 of inserting a foam material 26 into at least a portion of the cavity 24 of the elongated tubular element 20 to reinforce that portion of the tubular element 20. The foam material 26 could be inserted into the cavity 24 through any suitable process. For example, the foam material 26 could be injected into the cavity 24 with an injector 428 (such as the one shown in FIG. 6 and discussed in further detail below) or it could be inserted as a plug (not shown) and allowed to expand to fill the cross-sectional area of the cavity 24. The entire length of the cavity 24 may, but does not have to, be filled with the foam material 26, and the type and density of the foam material 26 can be varied in different portions of the tubular element 20. The type of foam material 26 may be resistant to very high temperatures to allow the tubular element 20 to be welded, for example to other portions of the back frame or the lower seat frame of the vehicle seat without any degradation in the foam material 26.

The exemplary method of FIG. 3 then continues with the steps 104, 106 of selectively heating and bending the tubular element 20 at the heated portions to conform the tubular element 20 to its final shape. The selective areas of the tubular element 20 are preferably heated with a laser beam. However, any desirable heating process could alternately be employed. Heating the tubular element 20 allows it to be bent to smaller bend radiuses and reduces internal stresses at the bends. On the contrary, if the tubular element 20 is not heated before bending, then it may crimp or otherwise deform if bent too sharply. If the foam material 26 is positioned in the portions of the tubular element 20 to be bent, then the tubular element 20 is heated to a temperature which will not degrade the foam material 26 disposed therein. For example, if the foam material 26 is resilient to temperatures of up to one hundred degrees Fahrenheit (100° F.), then the portions of the tubular element 20 containing that foam material 26 are not heated above this temperature before bending. Once bent and cooled, the exemplary method continues with the step 108 of utilizing the tubular element 20 as at least a portion of either the back frame or the lower seat frame of a vehicle seat. This exemplary method may be advantageous because it allows the foam material 26 to be inserted into the cavity 24 before the tubular element 20 is bent. This may provide for efficiency advantages as compared to inserting the foam material 26 after the tubular element 20 is bent.

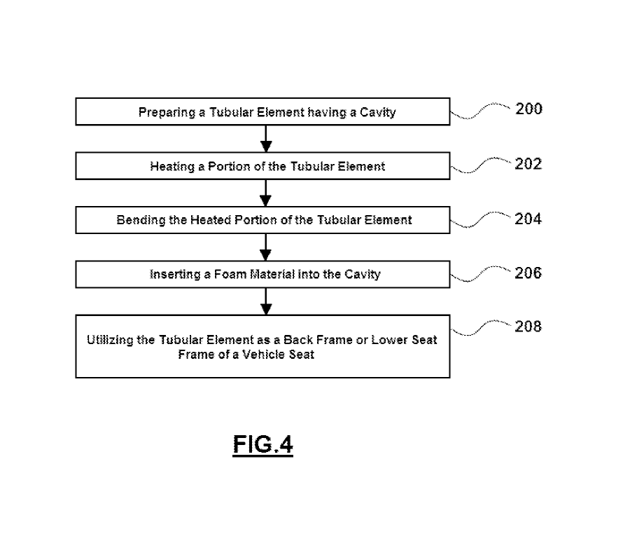

Referring now to FIG. 4, a flow chart of another exemplary method of forming a reinforced and bent tubular element 20 is shown. Similar to the above discussed method, this exemplary method includes the step 200 of preparing a tubular element 20 having a cavity 24 and a predetermined length. This exemplary method then continues with the steps 202, 204 of heating and bending the tubular element 20 at the heated portions to conform the tubular element 20 to its final shape. The tubular element 20 is preferably heated with a laser beam; however, any suitable heating process could alternately be employed. After the bending step 204 is complete, the method proceeds with the step 206 of inserting a foam material 26 into at least a portion of the cavity 24 of the tubular element 20. The entire length of the cavity 24 may, but does not have to, be filled with the foam material 26, and the type and density of the foam material 26 may be varied in different portions of the cavity 24. Additionally, the foam material 26 may be inserted into the cavity 24 through any suitable process. This exemplary method then continues with the step 208 of utilizing the tubular element 20 as at least a portion of the back frame or the lower seat frame of a vehicle seat. Inserting the foam material 26 into the cavity 24 only after the bending process is complete may be advantageous because, depending on the type or types of foam material(s) 26 being used, the tubular element 20 may be heated to higher temperatures before the bending process.

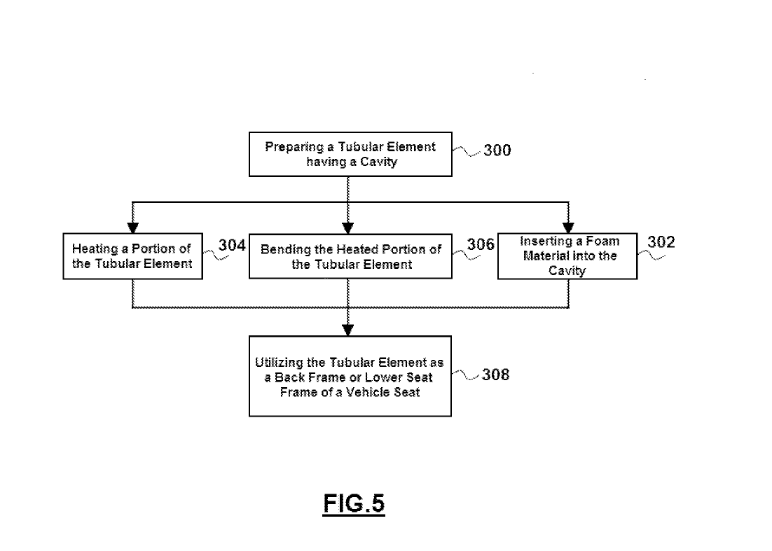

Referring now to FIG. 5, yet another exemplary method of forming a reinforced and bent tubular element 20 is shown. Similar to the embodiments discussed above, this embodiment starts with the step 300 of preparing a tubular element 20 having a cavity 24 and a predetermined length. The method then proceeds with the generally simultaneous steps 302, 304, 306 of inserting a foam material 26 into at least a portion of the cavity 24, selectively heating the tubular element 20 and bending the tubular element 20 to conform it to its final shape. As with the other embodiments, the entire length of the cavity 24 may, but does not have to, be filled with the foam material 26, and the type and density of the foam may be varied in different portions of the cavity 24. Additionally, the foam material 26 may be inserted into the cavity 24 through any suitable process and the tubular element 20 may be heated and bent through any suitable processes. After the foam insertion, heating and bending processes are complete, then the method continues with the step 308 of utilizing the tubular element 20 as at least a portion of the back frame or the lower seat frame of a vehicle seat.

Referring now to FIG. 6, an exemplary injector 428 is shown disposed in the cavity 424 of an exemplary tubular element 420 for injecting the foam material 426 into the cavity 424. As shown, the injector 428 has a radially outwardly extending flange 430 which generally matches the cross-section of the tubular element 420.

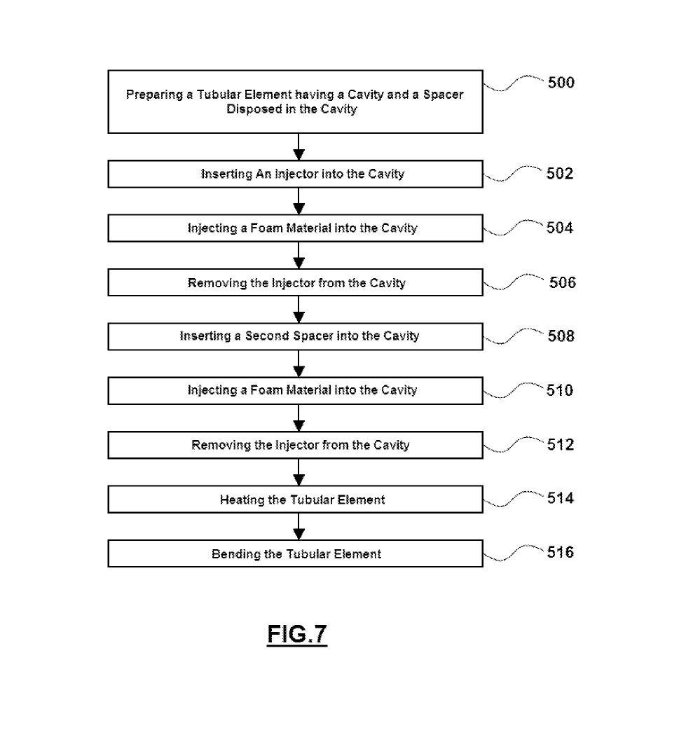

Another exemplary method of forming a bent and reinforced tubular element 420 is shown in the flow chart of FIG. 7. With reference to both this flow chart and to FIG. 6, the method includes the step 500 of preparing at least one elongated tubular element 420 having a cavity 424 and extending lengthwise between opposite ends with at least one of the opposite ends being open and with at least one spacer 432 being disposed in the cavity 424 between the opposite ends. The method then continues with the step 502 of inserting the injector 428 into the cavity 424 of the tubular element 420 through an open end to a position with the flange 430 being spaced from the spacer 432. The method then proceeds with the step 504 of injecting a foam material 426 into the cavity 424 of the elongated tubular element 420 between the spacer 432 and the flange 430 of the injector 428. The foam material 426 is preferably injected into the gap between the spacer 432 and flange 430 of the injector 428 as a resin, which then expands to fill the gap between the spacer 432 and flange 430 of the injector 428. The foam material 426 may be elected to have a predetermined density. Next, the method proceeds with the step 506 of removing the injector 428 from the cavity 424. The expanded foam material 426 will remain in its location within the cavity 424 of the elongated tubular element 420 after the injector 428 has been removed.

The exemplary method additionally includes the step 508 of inserting a second spacer 432 into the cavity 424 spaced from the foam material 426 previously injected therein. The method then proceeds with the step 510 of re-inserting the injector 428 with the radially outwardly extending flange 430 into the cavity 424 to a position spaced from the second spacer 432. The method then continues with the step 510 of injecting a foam material into the cavity 424 between the second spacer 432 and the flange 430 of the injector 428. The foam material injected into this portion of the cavity 424 may be the same as or different from the foam material 426 in the other portion of the cavity 424. Additionally, it may be injected to have the same density as or a different density from the foam material 426 injected into the other portion of the cavity 424. After the foam material is injected into the gap between the second spacer 432 and the flange 430, then the method proceeds with the step of removing the injector 428 from the cavity 424 of the elongated tubular element 420.

The exemplary method additionally includes the steps 514, 516 of heating at least a portion of the elongated tubular element 420 and bending the elongated tubular element 420 at the heated portion. The heating and bending steps 514, 516 can precede, follow or be simultaneous with the injection step 510 described above. Additionally, the heating and bending steps 514, 516 could be a line induced thermal strain (LITS) process, whereby precise heating and cooling of predetermined portions of the elongated tubular element 420 cause the elongated tubular element 420 to bend without the application of an external force.

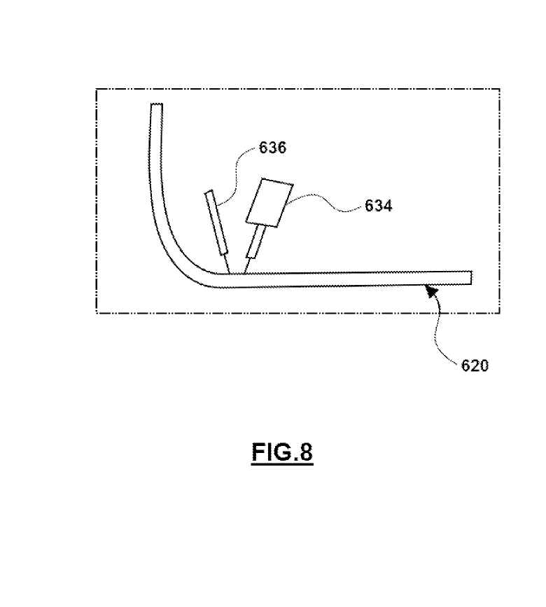

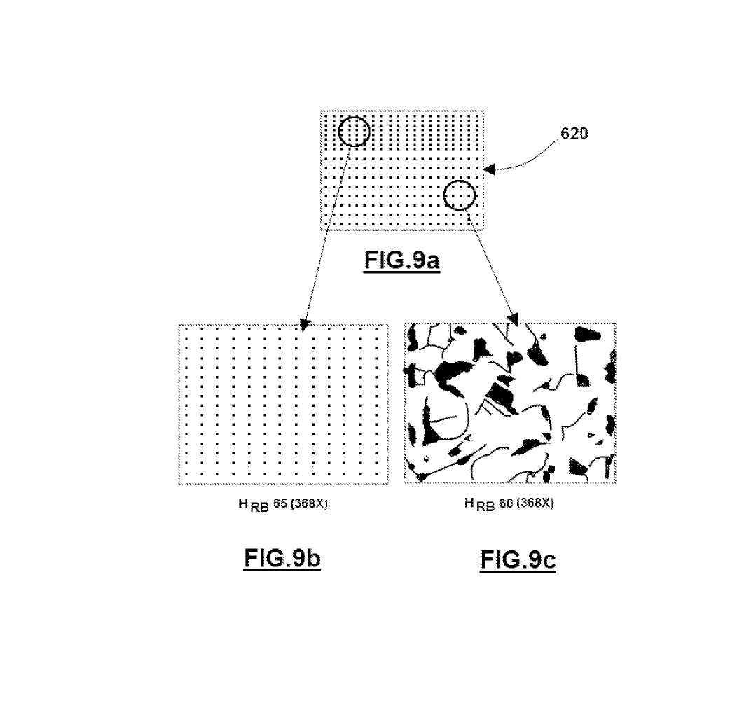

Referring now to FIG. 8, an exemplary elongated tubular element 620 is shown undergoing the LITS process with a laser head 634 serving as the heating source and a water jet 636 spraying water onto the tubular element 620. However, it should be appreciated that other heat sources and coolants could alternately be employed. As can be seen, the laser beam from the laser head 634 only heats one side of the elongated tubular element 620. The active cooling downstream of the laser head 634 causes internal stresses within the elongated tubular element 620, which in turn act to bend the elongated tubular element 620. As shown in FIGS. 9b and 9c, the microstructure of the material of the elongated tubular element 620 is different at different points of the material following the LITS forming process due to only a portion of the elongated tubular element 620 undergoing the heating and subsequent cooling processes. If desired, the elongated tubular element 620 could be heat treated after the LITS forming process is complete to make the microstructure of the material more uniform across the elongated tubular element 620.

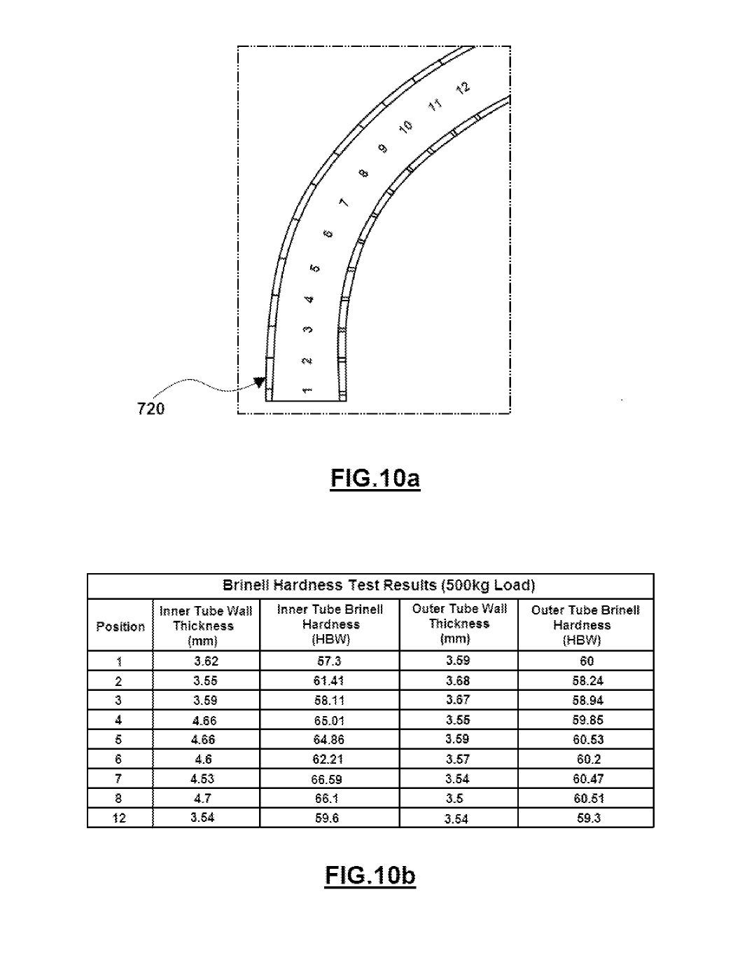

FIG. 10a is a cross-sectional view of an exemplary elongated tubular element 720 which was bent using the LITS forming process described above. The tubular element 720 is divided into a plurality of segments, which are numbered sequentially as 1 through 12. FIG. 10b is a table showing various measurements of the thickness and hardness of the inner and outer walls at segments 1-8 and 12 of the tubular element 720. As can be seen, the thickness of the inner wall of the tubular element 720 is greater in the middle portion of the bend (segments 4-8) than the beginning and end portions of the bend (segments 1-3 and 12). Further, the chart of FIG. 10b shows that the hardness of the tubular element 720 is greater throughout the length of the bend (segments 2-8) than at the straight segments of the tubular element 720 (segments 1 and 12). Also shown in FIG. 10b, the outer wall thickness and hardness of the tubular element 720 remain statistically constant along the bend.

The LITS forming process may be advantageous because the roundness of the bend can be maintained without leaving tool marks. Further, tubular elements formed through the LITS process have improved hydroformability because a pre-straining process is not required and because there is no thinning of the outer wall of the tubular element.

When the LITS process is employed to bend the tubular element, a foam precursor could be inserted into the cavity into a specific location prior to the heating of the tubular element in the LITS process. The LITS process then may activate the precursor, causing it to expand into the reinforcing foam material. This is yet another example of how the foam material can be inserted into the tubular element.

The foregoing invention has been described in accordance with the relevant legal standards, thus the description is exemplary rather than limiting in nature. Variations and modifications to the disclosed embodiment may become apparent to those skilled in the art and fall within the scope of the invention.

What is claimed is:

1. A vehicle seat frame assembly, comprising:
at least one elongated tubular element having a cavity, and wherein said at least one elongated tubular element extends between distal ends and has at least one bend between said distal ends; and
a foam material disposed in said cavity of said elongated tubular element and completely filling the cross-sectional area of said cavity through at least a portion of the length of said elongated tubular element and wherein said foam material has at least one of a varying type and a varying density along said portion of the length of said cavity.

2. A vehicle seat frame assembly as set forth in claim 1 wherein said foam material is disposed in less than the entire length of said cavity.

3. A vehicle seat frame assembly as set forth in claim 2 wherein said foam material is disposed in at least two locations of said cavity and wherein said at least two locations with said foam material are spaced from one another by a portion of said cavity free of said foam material.

4. A method of forming a vehicle seat frame, comprising the steps of:
preparing at least one elongated tubular element having a cavity and extending lengthwise between opposite ends;
inserting a foam material into at least a portion of the cavity of the elongated tubular element;
heating at least a portion of the elongated tubular element; and
bending the elongated portion of the elongated tubular element at the heated location.

5. The method of forming a vehicle seat frame as set forth in claim 4 wherein said steps of heating and bending at least a portion of the elongated tubular element are further defined as heating and bending the tubular element through a line induced thermal strain forming process wherein precise heating and cooling of predetermined portions of the elongated tubular element cause the elongated tubular element to bend.

6. The method of forming a vehicle seat frame as set forth in claim 4 wherein said step of inserting the foam material into at least a portion of the cavity of the elongated tubular element precedes said steps of heating and bending at least a portion of the elongated tubular element.

7. The method of forming a vehicle seat frame as set forth in claim 4 wherein said step of inserting the foam material into at least a portion of the cavity of the elongated tubular element follows said steps of heating and bending at least a portion of the elongated tubular element.

8. The method of forming a vehicle seat frame as set forth in claim 4 further including the step of welding the elongated tubular element after the step of inserting the foam material into the cavity of the elongated tubular element.

9. The method of forming a vehicle seat frame as set forth in claim 4 wherein said step of inserting the foam material into the cavity is further defined as injecting the foam material into the cavity with an injector having a radially outwardly extending flange and further including after the steps of:
removing the injector from the cavity:
inserting a spacer into the cavity spaced from the foam material previously injected into the cavity;
re-inserting the injector with the radially outwardly extending flange into the cavity to a position spaced from the spacer;
injecting a foam material with the injector into the cavity between the second spacer and the flange of the injector; and
removing the injector from the cavity of the elongated tubular element.

10. The method of forming a vehicle seat frame as set forth in claim 9 wherein the foam materials injected into the different locations of the cavity are of different materials from one another.

11. The method of forming a vehicle seat frame as set forth in claim 9 wherein the foam materials injected into the different locations of the cavity have different densities from one another.

12. A method of forming a vehicle seat frame, comprising the steps of:
preparing at least one elongated tubular element having a cavity and extending lengthwise between opposite ends with at least one of the opposite ends being open and with at least one spacer being disposed in said cavity between said opposite ends;
inserting an injector having a radially outwardly extending flange into the cavity of the at least one elongated tubular element through said at least one open end to a position with the flange being spaced from the spacer;
injecting a foam material into the cavity of the elongated tubular element between the spacer and the flange of the injector;
removing the injector from the cavity of the elongated tubular element;
heating at least a portion of the elongated tubular element; and
bending the elongated tubular element at the heated portion.

13. The method of forming a vehicle seat frame as set forth in claim 12 wherein the step of injecting the foam material into the cavity of the elongated tubular precedes the steps of heating and bending the elongated tubular element.

14. The method of forming a vehicle seat frame as set forth in claim 12 wherein the step of injecting the foam material into the cavity of the elongated tubular element is simultaneous with at least one of the steps of heating and bending the elongated tubular element.

15. The method of forming a vehicle seat frame as set forth in claim 12 wherein the step of injecting the foam material into the cavity of the elongated tubular element follows the steps of heating and bending the elongated tubular element.

16. The method of forming a vehicle seat frame as set forth in claim 12 further including after the step of removing the injector from the cavity the steps of:
inserting a second spacer into the cavity spaced from the foam material previously injected into the cavity;
re-inserting the injector with the radially outwardly extending flange into the cavity to a position spaced from the second spacer;
injecting a foam material with the injector into the cavity between the second spacer and the flange of the injector; and
removing the injector from the cavity of the elongated tubular element.

17. The method of forming a vehicle seat frame as set forth in claim 16 wherein the foam materials injected into the different locations of the cavity are of different materials from one another.

18. The method of forming a vehicle seat frame as set forth in claim 16 wherein the foam materials injected into the different locations of the cavity have different densities from one another.

19. The method of forming a vehicle seat frame as set forth in claim 12 wherein said steps of heating and bending at least a portion of the elongated tubular element are further defined as heating and bending the tubular element through a line induced thermal strain forming process wherein precise heating and cooling of predetermined portions of the elongated tubular element cause the elongated tubular element to bend.
